(19) United States
(12) Patent Application Publication
(10) Pub. No.: US 2016/0170544 A1
(43) Pub. Date: Jun. 16, 2016

(54) DISPLAY PANEL AND REPAIR METHOD THEREOF

(71) Applicant: SHENZHEN CHINA STAR OPTOELECTRONICS TECHNOLOGY CO., LTD., Shenzhen, Guangdong (CN)

(72) Inventors: Fang Wang, Shenzhen, Guangdong (CN); Zhiyuan Shen, Shenzhen, Guangdong (CN); Wei Zhan, Shenzhen, Guangdong (CN)

(21) Appl. No.: 14/416,992

(22) PCT Filed: Dec. 18, 2014
(86) PCT No.: PCT/CN2014/094171

§ 371 Date: Jan. 23, 2015

(30) Foreign Application Priority Data
Dec. 10, 2014 (CN) 201410755988.2

(51) Int. Cl. G06F 3/041; G06F 3/047

(52) U.S. Cl. CPC G06F 3/0416; G06F 3/0412; G06F 3/047; G06F 2203/04103

(57) ABSTRACT

The present invention discloses a display panel and a repair method thereof. The display panel comprises a pixel array substrate, a signal processor, a touch sensing layer and a repair wiring. The touch sensing layer comprises a sensing electrode, a first insulative layer, a wiring layer; the wiring in the wiring layer is employed to receive a touch sensing signal and transmit the touch sensing signal to the signal processor; the repair wiring is employed to replace the wiring to transmit the touch sensing signal when broken defect happens to the wiring. The present invention is capable of reducing the defect rate of the display panel.

### FIELD OF THE INVENTION

The present invention relates to a display technology field, and more particularly to a display panel and a repair method thereof.

### BACKGROUND OF THE INVENTION

In the traditional display panel, a sensing electrode layer is generally integrated to achieve the touch sensing function.

The sensing electrode layer is formed inside the display panel during the manufacture process of the display panel in general.

However, in the formation of the sensing electrode layer, broken defect may happen to the conducting line for transmitting the touch sensing signal. These existing broken defects can cause malfunction of the corresponding touch sensing area, and even result in the scrap of the display panel.

Consequently, there is a need to propose a new technical solution to solve the foregoing issue.

### SUMMARY OF THE INVENTION

An objective of the present invention is to provide a display panel and a repair method thereof, which can realize the repair to the display panel when wiring broken defect happens to reduce the defect rate of the display panel.

For solving the aforesaid issue, the technical solution of the present invention is described below:

A display panel, wherein the display panel comprises: a pixel array substrate; a signal processor; a touch sensing layer, located inside the pixel array substrate, and the touch sensing layer is coupled to the signal processor, and the touch sensing layer comprises: a sensing electrode layer, and the sensing electrode layer comprises: a sensing electrode array, and the sensing electrode array comprises at least two sensing electrodes arranged in a form of array; a first insulative layer; and a wiring layer, and the wiring layer comprises: at least one wiring, and the wiring is coupled to the sensing electrode and the signal processor, and the wiring is employed to receive a touch sensing signal generated by the sensing electrode, and transmit the touch sensing signal to the signal processor; wherein the first insulative layer is located on the wiring layer, and the sensing electrode layer is located on the first insulative layer; at least one repair wiring, and the repair wiring is employed to replace the wiring to transmit the touch sensing signal when broken defect happens to the wiring; the wiring layer and the repair wiring are insulative to each other; the repair wiring surrounds the sensing electrode array; the wiring is coupled to the sensing electrode via a through hole; the wiring comprises a first section and a second section, and the first section and the second section are connected; a first end of the first section is coupled to the sensing electrode via the through hole, and a second end of the first section extends to an area corresponding to an periphery of the sensing electrode array; a third end of the second section is coupled to the sensing electrode via the through hole, and a fourth end of the second section is coupled to the signal processor; the repair wiring is located on the area corresponding to the periphery of the sensing electrode array; the repair wiring is employed to establish connection with the wiring to transmit the touch sensing signal to the signal processor when broken defect happens to the second section.

In the aforesaid display panel, the repair wiring is employed to respectively establish connections with the first section and the second section to transmit the touch sensing signal to the signal processor via the first section, the repair wiring and the second section when broken defect happens to the second section of the wiring; two ends of the repair wiring are connected; the repair wiring comprises a third section and a fourth section; the third section of the repair wiring is employed to disconnect with the fourth section and respectively establish connections with the first section and the second section when broken defect happens to the second section.

In the aforesaid display panel, the third section and the fourth section are disconnected by laser cutting; the third section and the first section are connected by the laser welding; the third section and the second section are connected by the laser welding.

In the aforesaid display panel, the repair wiring is located in a layer where the sensing electrode layer is.

In the aforesaid display panel, the repair wiring is located between a first metal layer and a second metal layer, wherein the first metal layer is a layer where scan lines of an array line layer are, and the second metal layer is a layer where data lines of the array line layer are, and a second insulative layer is located between the repair wiring and the first metal layer, and a third insulative layer is located between the repair wiring and the second metal layer.

In the aforesaid display panel, the repair wiring is located on a layer where data lines of an array line layer are, and a fourth insulative layer is located between the repair wiring and the layer where data lines of the array line layer are, and a fifth insulative layer is located on the repair wiring and the wiring layer is located on the fifth insulative layer.

A display panel, wherein the display panel comprises: a pixel array substrate; a signal processor; a touch sensing layer, located inside the pixel array substrate, and the touch sensing layer is coupled to the signal processor, and the touch sensing layer comprises: a sensing electrode layer, and the sensing electrode layer comprises: a sensing electrode array, and the sensing electrode array comprises at least two sensing electrodes arranged in a form of array; a first insulative layer; and a wiring layer, and the wiring layer comprises: at least one wiring, and the wiring is coupled to the sensing electrode and the signal processor, and the wiring is employed to receive a touch sensing signal generated by the sensing electrode, and transmit the touch sensing signal to the signal processor; wherein the first insulative layer is located on the wiring layer, and the sensing electrode layer is located on the first insulative layer; at least one repair wiring, and the repair wiring is employed to replace the wiring to transmit the touch sensing signal when broken defect happens to the wiring.

In the aforesaid display panel, the wiring is coupled to the sensing electrode via a through hole; the wiring comprises a first section and a second section, and the first section and the second section are connected; a first end of the first section is coupled to the sensing electrode via the through hole, and a second end of the first section extends to an area corresponding to an periphery of the sensing electrode array; a third end of the second section is coupled to the sensing electrode via the through hole, and a fourth end of the second section is coupled to the signal processor.

In the aforesaid display panel, the repair wiring is located on the area corresponding to the periphery of the sensing electrode array; the repair wiring is employed to establish connection with the wiring to transmit the touch sensing signal to the signal processor when broken defect happens to the second section.

In the aforesaid display panel, the repair wiring is employed to respectively establish connections with the first section and the second section to transmit the touch sensing signal to the signal processor via the first section, the repair wiring and the second section when broken defect happens to the second section of the wiring.

In the aforesaid display panel, two ends of the repair wiring are connected; the repair wiring comprises a third section and a fourth section; the third section of the repair wiring is employed to disconnect with the fourth section and respectively establish connections with the first section and the second section when broken defect happens to the second section.

In the aforesaid display panel, the third section and the fourth section are disconnected by laser cutting; the third section and the first section are connected by the laser welding; the third section and the second section are connected by the laser welding.

In the aforesaid display panel, the repair wiring is located in a layer where the sensing electrode layer is.

In the aforesaid display panel, the wiring layer and the repair wiring are insulative to each other.

In the aforesaid display panel, the repair wiring surrounds the sensing electrode array.

In the aforesaid display panel, the repair wiring is located between a first metal layer and a second metal layer, wherein the first metal layer is a layer where scan lines of an array line layer are, and the second metal layer is a layer where data lines of the array line layer are, and a second insulative layer is located between the repair wiring and the first metal layer, and a third insulative layer is located between the repair wiring and the second metal layer.

In the aforesaid display panel, the repair wiring is located on a layer where data lines of an array line layer are, and a fourth insulative layer is located between the repair wiring and the layer where data lines of the array line layer are, and a fifth insulative layer is located on the repair wiring and the wiring layer is located on the fifth insulative layer.

A repair method of the display panel according to claim 7, wherein the method comprises steps of: A, establishing connecting between the repair wiring and the wiring when broken defect happens to the wiring. B, disconnecting the third section of the repair wiring with fourth section of the repair wiring.

In the repair method of the display panel, the step A comprises a step of: a1, establishing connection between the first section of the wiring and the third section, and establishing connection between the second section and the third section by laser welding.

In the repair method of the display panel, the step B comprises a step of: b1, disconnecting the third section and the fourth section by laser cutting.

Compared with prior arts, the present invention is capable of realizing the repair to the display panel when wiring broken defect happens to reduce the defect rate of the display panel.

For a better understanding of the aforementioned content of the present invention, preferable embodiments are illustrated in accordance with the attached figures for further explanation.

### BRIEF DESCRIPTION OF THE DRAWINGS

FIG. 1 is a sectional diagram of a display panel according to the present invention;

FIG. 2 is a sectional diagram of a touch sensing layer shown in FIG. 1;

FIG. 3 is a diagram of a display panel according to the first embodiment of the present invention;

FIG. 4 is a diagram of a repair way of the display panel shown in FIG. 3;

FIG. 5 is a flowchart of a repair method of the display panel according to the first embodiment of the present invention;

FIG. 6 is a flowchart of a repair method of the display panel according to the second embodiment of the present invention.

### DETAILED DESCRIPTION OF PREFERRED EMBODIMENTS

The word, “an embodiment” used in this specification means serving as an example, an instance, or an illustration. Besides, in this specification and the appended claims, the articles “a” generally means “one or more” unless specified otherwise or the singular form can be clearly confirmed in the context.

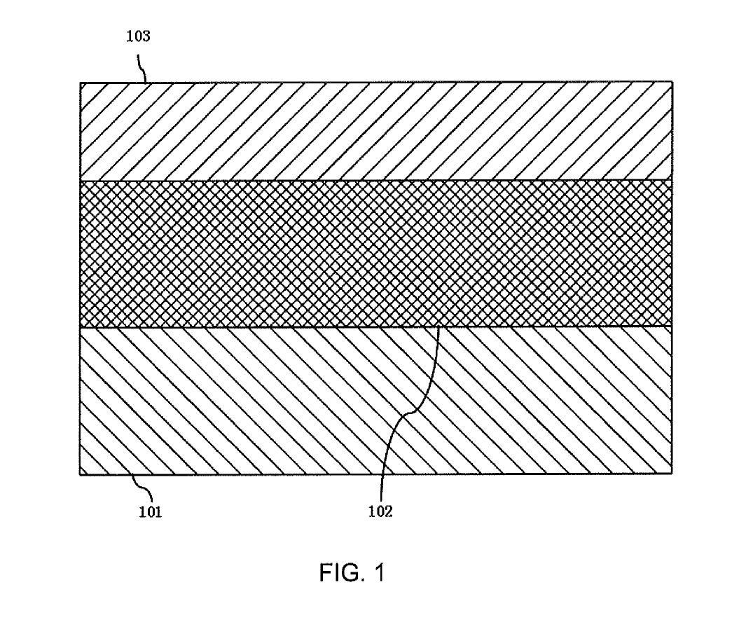

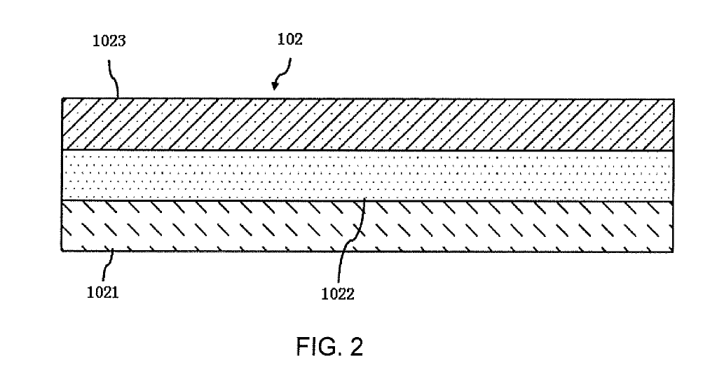

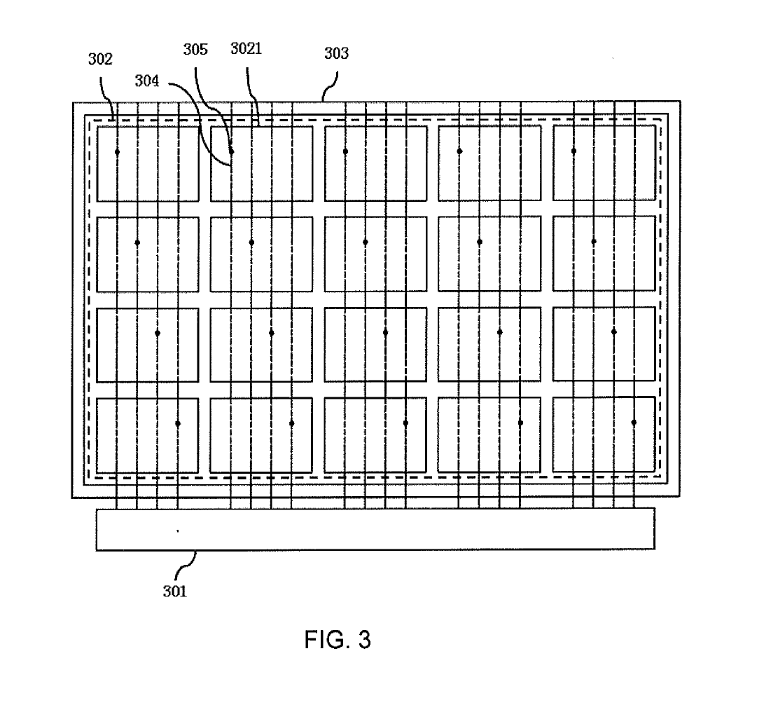

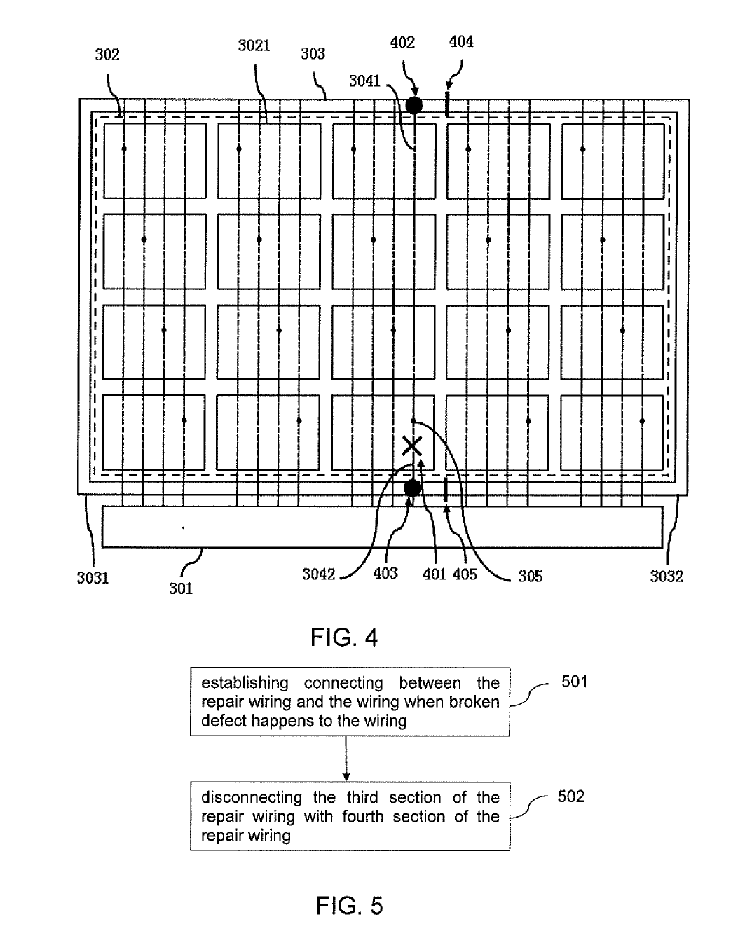

Please refer to FIG. 1, FIG. 2, FIG. 3 and FIG. 4. FIG. 1 is a sectional diagram of a display panel according to the present invention. FIG. 2 is a sectional diagram of a touch sensing layer shown in FIG. 1. FIG. 3 is a diagram of a display panel according to the first embodiment of the present invention. FIG. 4 is a diagram of a repair way of the display panel shown in FIG. 3.

The display panel of the present invention comprises a pixel array substrate, a signal processor 301, a touch sensing layer 102. The display panel of the present invention can be a TFT-LCD (Thin Film Transistor Liquid Crystal Display), an OLED (Organic Light Emitting Diode display panel), et cetera.

The touch sensing layer 102 is located inside the pixel array substrate. As the display panel is a thin film transistor display panel, the pixel array substrate is a thin film transistor array substrate, and the display panel further comprises a CF (color filter) substrate and a liquid crystal layer. The thin film transistor array substrate comprises a pixel electrode layer 103 and an array line layer. The touch sensing layer 102 is located between the pixel electrode layer 103 and the array line layer 101. The array line layer 101 comprises a substrate, scan lines, TFT (Thin Film Transistor) switches, data lines, et cetera.

The touch sensing layer 102 is coupled to the signal processor 301, and the touch sensing layer 102 comprises a sensing electrode layer 1023, a first insulative layer 1022 and a wiring layer 1021. The wiring layer 1021 is located on the array line layer 101, and the first insulative layer 1022 is located on the wiring layer 1021, and the sensing electrode layer 1023 is located on the first insulative layer 1022.

The sensing electrode layer 1023 comprises a sensing electrode array 302, and the sensing electrode array 302 comprises at least two sensing electrodes 3021, and the at least two sensing electrodes 3021 are arranged in a form of array (two dimension array). In this embodiment, the sensing electrode array 302 comprises at least two sensing electrode lines. The straight line where the sensing electrode line is is parallel with the straight line where the scan line is.

The wiring layer 1021 at least one wiring 304. The wiring 304 is coupled to the sensing electrode 3021 and the signal processor 301. The wiring 304 is employed to receive a touch sensing signal generated by the sensing electrode 3021, and transmit the touch sensing signal to the signal processor 301. The straight line where the wiring 304 is is perpendicular to the straight line where the scan line is.

The display panel further comprises at least one repair wiring 303. The repair wiring 303 is employed to replace the wiring 304 to transmit the touch sensing signal when broken defect 401 happens to the wiring 304.

The wiring layer 1021 and the repair wiring 303 are insulative to each other.

In this embodiment, the wiring 304 is coupled to the sensing electrode 3021 via a through hole 305. The wiring 304 comprises a first section 3041 and a second section 3042, and the first section 3041 and the second section 3042 are connected.

A first end of the first section 3041 is coupled to the sensing electrode 3021 via the through hole 305, and a second end of the first section 3041 extends to an area corresponding to an periphery of the sensing electrode array 302. A third end of the second section 3042 is coupled to the sensing electrode 3021 via the through hole 305, and a fourth end of the second section 3042 is coupled to the signal processor 301.

The repair wiring 303 is located on the area corresponding to the periphery of the sensing electrode array 302. The repair wiring 303 is employed to establish connection with the wiring 304 (the connection position are a first connection position 402 and a second connection position 403) to transmit the touch sensing signal to the signal processor 301 when broken defect 401 happens to the second section 3042.

Specifically, the repair wiring 303 is employed to respectively establish connections with the first section 3041 and the second section 3042 (the connection position are the first connection position 402 and the second connection position 403) to transmit the touch sensing signal to the signal processor 301 via the first section 3041, the repair wiring 303 and the second section 3042 when broken defect 401 happens to the second section 3042.

Two ends of the repair wiring 303 are connected. The appearance of the repair wiring 303 is a rectangular ring, and the repair wiring 303 surrounds the sensing electrode array 302.

The repair wiring 303 comprises a third section 3031 and a fourth section 3032. The third section 3031 of the repair wiring 303 is employed to disconnect with the fourth section 3032 (the disconnection position are/is a first disconnection position 404 and/or a second disconnection position 405) and respectively establish connections with the first section 3041 and the second section 3042 (the connection position are the first connection position 402 and the second connection position 403) when broken defect 401 happens to the second section 3042.

The third section 3031 and the fourth section 3032 are disconnected by laser cutting. The third section 3031 and the first section 3041 are connected by the laser welding. The third section 3031 and the second section 3042 are connected by the laser welding.

In this embodiment, the repair wiring 303 is located in a layer where the sensing electrode layer 1023 is.

With the aforesaid technical solution, the repair wiring 303 can be employed to eliminate the broken detect 401 when the broken defect 401 happens to the wiring 304 of the display panel. That is to say, with the repair of the repair wiring 303 to the display panel, the defect rate of the display panel can be reduced.

The second embodiment of the display panel is similar with the foregoing first embodiment. The difference is:

The repair wiring 303 is located inside the array line layer 101. For instance, the repair wiring 303 is located between a first metal layer and a second metal layer, wherein the first metal layer is a layer where scan lines of an array line layer are, and the second metal layer is a layer where data lines of the array line layer are, and a second insulative layer is located between the repair wiring 303 and the first metal layer, and a third insulative layer is located between the repair wiring 303 and the second metal layer; alternatively, the repair wiring 303 is located on a layer where data lines of an array line layer are, and a fourth insulative layer is located between the repair wiring 303 and the layer where data lines of the array line layer are, and a fifth insulative layer is located on the repair wiring and the wiring layer 1021 is located on the fifth insulative layer.

Please refer to FIG. 5. FIG. 5 is a flowchart of a repair method of the display panel according to the first embodiment of the present invention. The repair method of the display panel according to the embodiment comprises steps of:

A (step 501), establishing connecting between the repair wiring 303 and the wiring 304 when broken defect 401 happens to the wiring 304;

B (step 502), disconnecting the third section 3031 of the repair wiring 303 with fourth section 3032 of the repair wiring 303.

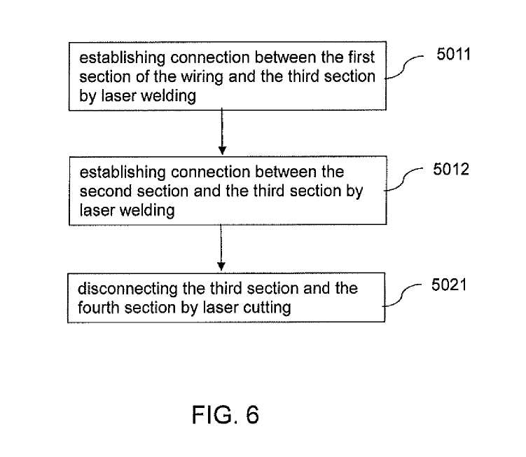

Please refer to FIG. 6. FIG. 6 is a flowchart of a repair method of the display panel according to the second embodiment of the present invention. The second embodiment is similar with the foregoing first embodiment. The difference is:

The step A (step 501) comprises a step of:

a1 (step 5011), establishing connection between the first section 3041 of the wiring 304 and the third section 3031 by laser welding when broken defect 401 happens to the second section 3042 of the wiring 304 (the connection position is a first connection position 402);

a2 (step 50112), establishing connection between the second section 3042 and the third section 3031 (the connection position is a second connection position 403).

The step B comprises a step of:

b1 (step 50211), disconnecting the third section 3031 and the fourth section 3032 by laser cutting (the disconnection position are/is a first disconnection position 404 and/or a second disconnection position 405).

With the aforesaid technical solution, the repair wiring 303 can be employed to eliminate the broken detect 401 when the broken defect 401 happens to the wiring 304 of the display panel. That is to say, with the repair of the repair wiring 303 to the display panel, the defect rate of the display panel can be reduced.

Despite relative to one or more implementations shown and described the present disclosure, those skilled in the art based on the present specification and drawings will occur upon reading and understanding the equivalent variations and modifications. The present disclosure includes all such modifications and variations, and only by the scope of the appended claims limit. Particularly with regard to various functions performed by the above-described components (e.g., elements, resources, etc.) performed, the terms used to describe such components are intended to perform the function corresponding to the specified component (e.g., which is functionally equivalent) of any of the components (unless otherwise indicated), even if the structure of the implementation and execution of the function of the present disclosure shown herein disclosed exemplary not structurally equivalent. Additionally, although a particular feature of the present disclosure has been made with respect to certain implementations, only one is open, but this feature may be as given or particular application and the purpose of enabling a desired one or more other implementations Other combinations of features. Moreover, the terms “comprising,” “having,” “containing,” or variants thereof are used in the detailed description or the claims, such a term is intended to the term “comprising” includes similar manner.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A display panel, wherein the display panel comprises:
a pixel array substrate;
a signal processor;
a touch sensing layer, located inside the pixel array substrate, and the touch sensing layer is coupled to the signal processor, and the touch sensing layer comprises:
a sensing electrode layer, and the sensing electrode layer comprises:
a sensing electrode array, and the sensing electrode array comprises at least two sensing electrodes arranged in a form of array;
a first insulative layer; and
a wiring layer, and the wiring layer comprises:
at least one wiring, and the wiring is coupled to the sensing electrode and the signal processor, and the wiring is employed to receive a touch sensing signal generated by the sensing electrode, and transmit the touch sensing signal to the signal processor;
wherein the first insulative layer is located on the wiring layer, and the sensing electrode layer is located on the first insulative layer;
at least one repair wiring, and the repair wiring is employed to replace the wiring to transmit the touch sensing signal when broken defect happens to the wiring;
the wiring layer and the repair wiring are insulative to each other;
the repair wiring surrounds the sensing electrode array;
the wiring is coupled to the sensing electrode via a through hole;
the wiring comprises a first section and a second section, and the first section and the second section are connected;
a first end of the first section is coupled to the sensing electrode via the through hole, and a second end of the first section extends to an area corresponding to an periphery of the sensing electrode array;
a third end of the second section is coupled to the sensing electrode via the through hole, and a fourth end of the second section is coupled to the signal processor;
the repair wiring is located on the area corresponding to the periphery of the sensing electrode array;
the repair wiring is employed to establish connection with the wiring to transmit the touch sensing signal to the signal processor when broken defect happens to the second section.

2. The display panel according to claim 1, wherein the repair wiring is employed to respectively establish connections with the first section and the second section to transmit the touch sensing signal to the signal processor via the first section, the repair wiring and the second section when broken defect happens to the second section;
two ends of the repair wiring are connected;
the repair wiring comprises a third section and a fourth section;
the third section of the repair wiring is employed to disconnect with the fourth section and respectively establish connections with the first section and the second section when broken defect happens to the second section.

3. The display panel according to claim 2, wherein the third section and the fourth section are disconnected by laser cutting;
the third section and the first section are connected by the laser welding;
the third section and the second section are connected by the laser welding.

4. The display panel according to claim 1, wherein the repair wiring is located in a layer where the sensing electrode layer is.

5. The display panel according to claim 1, wherein the repair wiring is located between a first metal layer and a second metal layer, wherein the first metal layer is a layer where scan lines of an array line layer are, and the second metal layer is a layer where data lines of the array line layer are, and a second insulative layer is located between the repair wiring and the first metal layer, and a third insulative layer is located between the repair wiring and the second metal layer.

6. The display panel according to claim 5, wherein the repair wiring is located on a layer where data lines of an array line layer are, and a fourth insulative layer is located between the repair wiring and the layer where data lines of the array line layer are, and a fifth insulative layer is located on the repair wiring and the wiring layer is located on the fifth insulative layer.

7. A display panel, wherein the display panel comprises:
a pixel array substrate;
a signal processor;
a touch sensing layer, located inside the pixel array substrate, and the touch sensing layer is coupled to the signal processor, and the touch sensing layer comprises:
a sensing electrode layer, and the sensing electrode layer comprises:
a sensing electrode array, and the sensing electrode array comprises at least two sensing electrodes arranged in a form of array;
a first insulative layer; and
a wiring layer, and the wiring layer comprises:
at least one wiring, and the wiring is coupled to the sensing electrode and the signal processor, and the wiring is employed to receive a touch sensing signal generated by the sensing electrode, and transmit the touch sensing signal to the signal processor;
wherein the first insulative layer is located on the wiring layer, and the sensing electrode layer is located on the first insulative layer;
at least one repair wiring, and the repair wiring is employed to replace the wiring to transmit the touch sensing signal when broken defect happens to the wiring.

8. The display panel according to claim 7, wherein the wiring is coupled to the sensing electrode via a through hole;
the wiring comprises a first section and a second section, and the first section and the second section are connected;
a first end of the first section is coupled to the sensing electrode via the through hole, and a second end of the first section extends to an area corresponding to an periphery of the sensing electrode array;
a third end of the second section is coupled to the sensing electrode via the through hole, and a fourth end of the second section is coupled to the signal processor.

9. The display panel according to claim 8, wherein the repair wiring is located on the area corresponding to the periphery of the sensing electrode array;
the repair wiring is employed to establish connection with the wiring to transmit the touch sensing signal to the signal processor when broken defect happens to the second section.

10. The display panel according to claim 9, wherein the repair wiring is employed to respectively establish connections with the first section and the second section to transmit the touch sensing signal to the signal processor via the first section, the repair wiring and the second section when broken defect happens to the second section of the wiring.

11. The display panel according to claim 10, wherein two ends of the repair wiring are connected;
the repair wiring comprises a third section and a fourth section;
the third section of the repair wiring is employed to disconnect with the fourth section and respectively establish connections with the first section and the second section when broken defect happens to the second section.

12. The display panel according to claim 11, wherein the third section and the fourth section are disconnected by laser cutting;
the third section and the first section are connected by the laser welding;
the third section and the second section are connected by the laser welding.

13. The display panel according to claim 7, wherein the repair wiring is located in a layer where the sensing electrode layer is.

14. The display panel according to claim 7, wherein the wiring layer and the repair wiring are insulative to each other.

15. The display panel according to claim 7, wherein the repair wiring surrounds the sensing electrode array.

16. The display panel according to claim 7, wherein the repair wiring is located between a first metal layer and a second metal layer, wherein the first metal layer is a layer where scan lines of an array line layer are, and the second metal layer is a layer where data lines of the array line layer are, and a second insulative layer is located between the repair wiring and the first metal layer, and a third insulative layer is located between the repair wiring and the second metal layer.

17. The display panel according to claim 7, wherein the repair wiring is located on a layer where data lines of an array line layer are, and a fourth insulative layer is located between the repair wiring and the layer where data lines of the array line layer are, and a fifth insulative layer is located on the repair wiring and the wiring layer is located on the fifth insulative layer.

18. A repair method of the display panel according to claim 7, wherein the method comprises steps of:
A, establishing connecting between the repair wiring and the wiring when broken defect happens to the wiring;
B, disconnecting the third section of the repair wiring with fourth section of the repair wiring.

19. The repair method of the display panel according to claim 17, wherein the step A comprises a step of:
a1, establishing connection between the first section of the wiring and the third section, and establishing connection between the second section and the third section by laser welding when broken defect happens to the second section of the wiring.

20. The repair method of the display panel according to claim 18, wherein the step B comprises a step of:
b1, disconnecting the third section and the fourth section by laser cutting.
